(19) United States
(12) Patent Application Publication
(10) Pub. No.: US 2016/0371739 A1
(43) Pub. Date: Dec. 22, 2016

(54) MARKETING PLATFORM

(71) Applicant: Lynda Chervil, Warwick, NY (US)

(72) Inventor: Lynda Chervil, Warwick, NY (US)

(21) Appl. No.: 15/147,534

(22) Filed: May 5, 2016

Related U.S. Application Data
(60) Provisional application No. 62/180,979, filed on Jun. 17, 2015.

(51) Int. Cl. G06Q 30/02; H04N 21/258; H04N 21/442; H04N 21/81; H04N 21/2668; H04N 21/478; H04N 21/234; H04N 21/25

(52) U.S. Cl. CPC G06Q 30/0269; H04N 21/23424; H04N 21/25883; H04N 21/252; H04N 21/812; H04N 21/2668; H04N 21/47815; H04N 21/44222

(57) ABSTRACT

A system for provisioning digital content to users is disclosed. The system includes a communication module configured for communicating with a client computer associated with a user of the plurality of users over a communication network. The system further includes a processor configured to identify a plurality of users corresponding to each of a lifestyle based demographic and an interest in a domain, identify digital content corresponding to each of the lifestyle demographic and the domain, embed a brand in the digital content, wherein the brand corresponds to at least one of a product and a service, wherein the brand is associated with at least one of eco-friendliness and sustainability and provision the digital content to the plurality of users.

### CROSS-REFERENCE TO RELATED APPLICATIONS

This application claims benefit of U.S. provisional patent application No. 62/180,979, filed on Jun. 17, 2015, which is incorporated herein by reference in its entirety.

### FIELD OF THE INVENTION

Generally, the disclosure invention relates to a digital new-media communications platform. More specifically, the disclosure relates to a digital new-media communications platform that promotes luxury brands with eco-friendly products and sustainable practices via targeted marketing extension strategies with branding initiatives.

### BACKGROUND

Traditional news media caters to a wide audience. Accordingly, the news media publishes content that is suited for various demographic profiles. They also allow advertisements to be placed along with their content. In general, the advertisements are also targeted to a wide audience. This practice is inefficient and often leads to lower number of conversions to sales. The audience often does not engage with the generic news content and the advertisements.

Therefore, niche news media platforms are becoming popular. Further, there is an increased focus on health and fitness, the environment, personal development, sustainable living, and social justice. However, often people do not want to sacrifice their existing standard of living in order to achieve other goals for themselves, the society or the environment. Therefore, there is a need for a method and system to identify solutions and present the solutions to the target audience such that the solutions match their current lifestyle or standard of living.

### SUMMARY

A system for provisioning digital content to users is disclosed. The system includes a communication module configured for communicating with a client computer associated with a user of the plurality of users over a communication network. The system further includes a processor configured to identify a plurality of users corresponding to each of a lifestyle based demographic and an interest in a domain, identify digital content corresponding to each of the lifestyle demographic and the domain, embed a brand in the digital content, wherein the brand corresponds to at least one of a product and a service, wherein the brand is associated with at least one of eco-friendliness and sustainability and provision the digital content to the plurality of users.

According to some embodiments, a method of provisioning digital content to users is disclosed. The method includes identifying, using a processor, a plurality of users corresponding to each of a lifestyle based demographic and an interest in a domain. The method further includes identifying, using a processor, digital content corresponding to each of the lifestyle demographic and the domain. Further the method includes embedding, using a processor, a brand in the digital content, wherein the brand corresponds to at least one of a product and a service, wherein the brand is associated with at least one of eco-friendliness and sustainability. Finally the method includes provisioning, using the processor, the digital content to the plurality of users.

According to some aspects, the disclosed system helps rebrand eco-friendly products and services that are currently in luxury brands' portfolio to increase awareness and deepen penetration within well targeted unique market segments via email marketing, in app marketing and social media campaigns with sponsored contents developed as custom content to uniquely position brands' products with ties to environmental sustainability and tangible efforts that luxury brands have made and intend to further advance environmental sustainability.

According to some other aspects, the disclosed method is used to develop multimedia properties that provide alternative marketing and advertising opportunities via product placement and sponsored branded content in media properties such as TV series, films and interactive games development.

According to some other aspects, the disclosed systems and methods are designed to increase the adoption rate of sustainable luxury consumer goods that represent market based solution to the environmental challenges of reducing carbon dioxide emissions, Tn the US, 28% of carbon dioxide emission comes from the transportation section and if more alternative vehicles such as electric vehicles, hybrid vehicles and clean diesel technology vehicles are purchased by the consuming public, individual carbon dioxide emissions per capita can be reduced and directly affect the overall reduction in carbon dioxide emissions from the transportation sector. Similarly, 38% of the carbon dioxide emissions in the US is caused by the electricity sector. If more green architecture homes, high end energy efficient appliances are purchased as well as consuming solar energy with the use of photovoltaic systems, the rate of carbon dioxide emissions form the electricity sector can be significantly reduced thereby accomplishing a social good while at the same time encouraging eco-friendly consumerism.

According to some aspects, the disclosed systems and methods are specifically used for promoting sustainable luxury brands and luxury brands with eco-friendly products and services. The custom content includes only showcase luxury brands of the same class and which helps project the same social status to readers who want to embrace a total eco-friendly luxury lifestyle. Similar luxury brands promoted in the same advertorial or editorial contents benefit of the hallow effect of co-branding on the same marketing platform. Therefore, the custom content, although promotional maintains a high level of integrity by balancing opinion pieces with a dose of objectivity.

According to some aspects, the disclosed systems provide market place that provides news, information and branded content by industry and lifestyle segments. For example, by having one publication that covers the transportation sector, another publication that covers alternative energy for household consumption, and yet another publication that covers high end green architecture, sustainable interior designs and high end durable goods for home use.

### BRIEF DESCRIPTION OF DRAWINGS

FIG. 1 illustrates an environment in which an embodiment of the present invention operates.

FIG. 2 is a block diagram of a system for provisioning digital content, in accordance with an embodiment.

FIG. 3 illustrates a flowchart of a method for provisioning digital content, in accordance with an embodiment.

FIG. 4 is a functional block diagram of a system for provisioning digital content, in accordance with an embodiment.

FIG. 5A illustrates a user interface of a cell phone, in accordance with an embodiment.

FIG. 5B illustrates a user interface of a cell phone, in accordance with an embodiment.

FIG. 5C illustrates a user interface of a cell phone, in accordance with an embodiment.

FIG. 6 illustrates an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary.

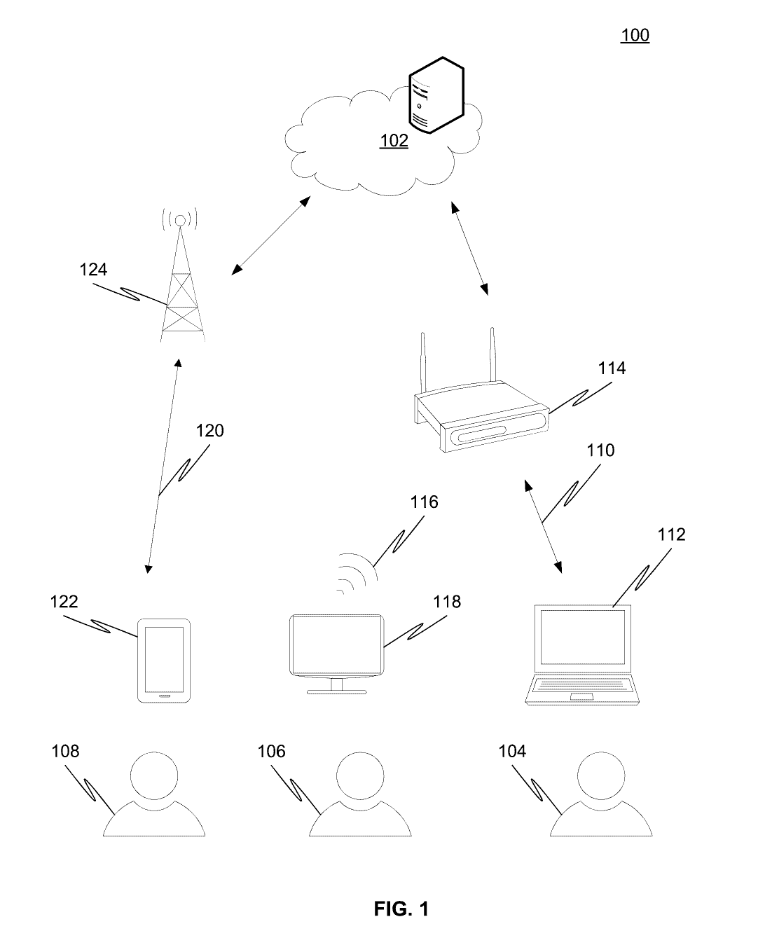

The present invention will be further illustrated with examples below. Referring first to FIG. 1 illustrating an environment 100 in which an embodiment of the present invention operates. The environment 100 includes a cloud server 102 configured to provision digital content over the Internet to a plurality of users 104-108. In an embodiment, the cloud server 102 provides a digital new-media communications platform that promotes luxury brands with eco-friendly products and sustainable practices via targeted marketing extension strategies with branding initiatives.

A user 104 may connect to the cloud server 102 via Internet through a wired connection 110 between a laptop 112 and a modem 114. Similarly, the user 106 may connect to the cloud server 102 via Internet through a wireless connection 116 (Wi-Fi connection) between a desktop computer 118 and a modem, which may be the modem 114. Similarly, the user 108 may connect to the cloud server 102 via Internet through a wireless connection 120 (which may one of 3G, LTE, Wi-Fi connection) between a cell phone 122 and a cell tower 124.

The users 104-108 may install a software application to receive and display content provisioned by the cloud server 102. Further, they may receive content via online messages including emails.

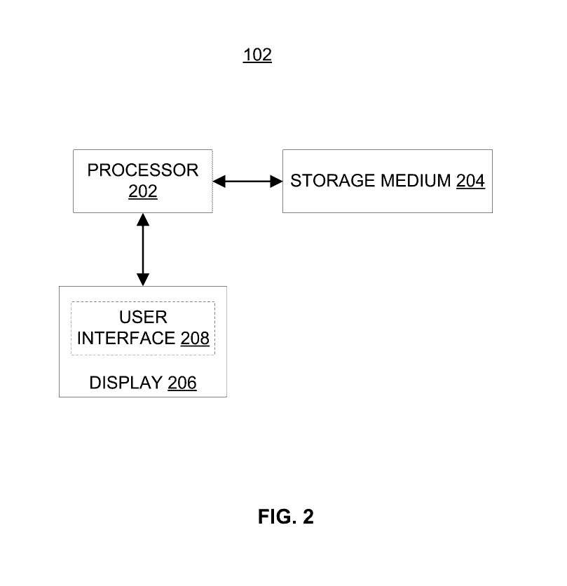

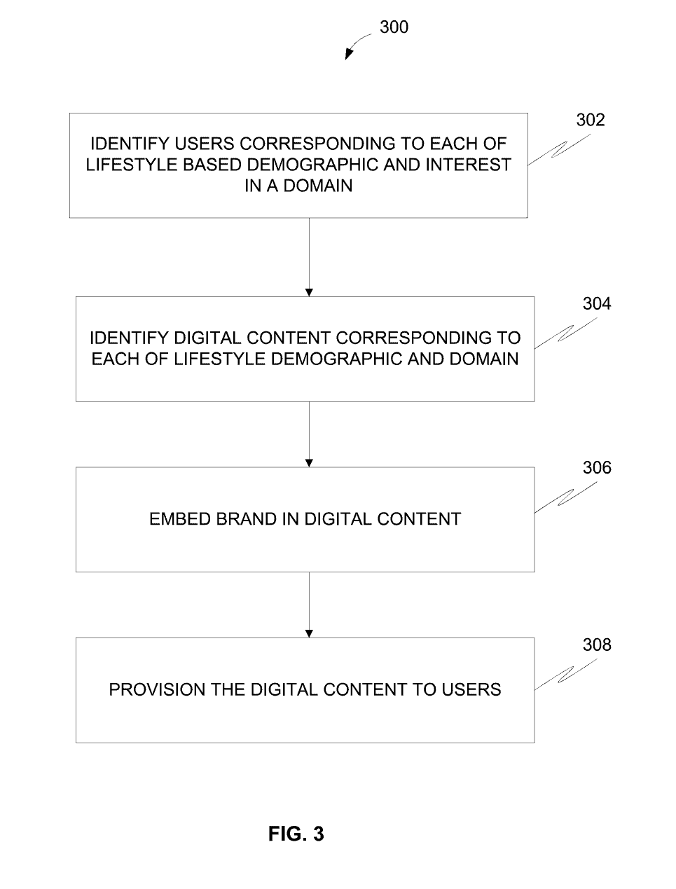

Now, referring to FIG. 2, the cloud server 102 for provisioning digital content is illustrated in accordance with an embodiment. The cloud server 102 includes one or more processors (for example, a processor 202), a storage medium (e.g., a memory) 204, and a display 206 (optional). Storage medium 204 stores instructions that, when executed by one or more processors 202, cause one or more processors 202 to provision digital content in accordance with various embodiments. This is explained in further detail in conjunction with FIGS. 3, 4 and 5 below. In an embodiment, storage medium 204 may be a computer readable medium. The cloud server 102 may interact with users via a user interface 208 accessible to the users via display device 206.

FIG. 3 illustrates a flowchart 300 of a method for provisional digital content to the one or more users 104-108, in accordance with an embodiment.

At 302, the cloud server 102 identifies at least one user corresponding to each of a lifestyle based demographic and an interest in a domain. The cloud server 102 may identify the at least one user based on analyzing data corresponding to user behavior, such as purchasing behavior.

The lifestyle of the at least one user may be associated with at least one of eco-friendliness and sustainability. Further, the lifestyle based demographic may include a Lifestyles of Health and Sustainability (LOHAS) demographic, which defines a particular market segment related to sustainable living, “green” ecological initiatives, and generally composed of a relatively upscale and well-educated population segment.

The domain includes at least one of alternative transport, alternative energy, climate change, biodiversity and conservation. In another embodiment, the domain may include at least one of auto sector, home sector, travel sector and general news.

Thereafter, at 304, the cloud server 102 identifies digital content corresponding to each of the lifestyle demographic and the domain. The digital content may include an entertainment content, such as one or more of a novel, a movie, a television series, an interactive game, a video and an interactive image. Further, the digital content may include an editorial content, a news content and a user generated content. Yet further, the digital content may include a native advertisement.

Next, at 306, the cloud server 102 embeds a brand in the digital content. The brand may correspond to at least one of a product and a service. Further, the brand may be luxury brand, such that the corresponding product includes a luxury product and the corresponding service includes a luxury service. Yet further, the brand is associated with at least one of eco-friendliness and sustainability; therefore, the corresponding product and/or service is associated with at least one of eco-friendliness and sustainability. Eco-friendly products and services inflict reduced, minimal, or no harm upon ecosystems or the environment. Sustainable products, processes and services are the ones that meets the needs and aspirations of the present without compromising the ability of future generations to meet their own needs.

In an embodiment, the embedding includes integrating at least one of the brand, the product and the service in a storyline corresponding to the entertainment content, wherein the storyline may be associated with at least one of eco-friendliness and sustainability. This help brands create new markets with organic integration and promotional extension activities. Further, this consistency based marketing strategy is expected to have a positive effect on how consumers respond to information.

Thereafter, at 308, the cloud server 102 provisions the digital content to the plurality of users. The digital content may be sponsored by an organization associated with the brand. Further, the digital content may include a sale offer to purchase at least one of the product and the service. Therefore, provisioning the digital content may result in recognition of at least one of the brand, the product and the service by the at least one user as associated with at least one of eco-friendliness and sustainability. The provisioning of the digital content may be performed through a software application, such as a mobile application installed on the cell phone 122.

The method for provisional digital content may further include communicating at least one marketing message to the at least one user. The marketing message is in the form of email.

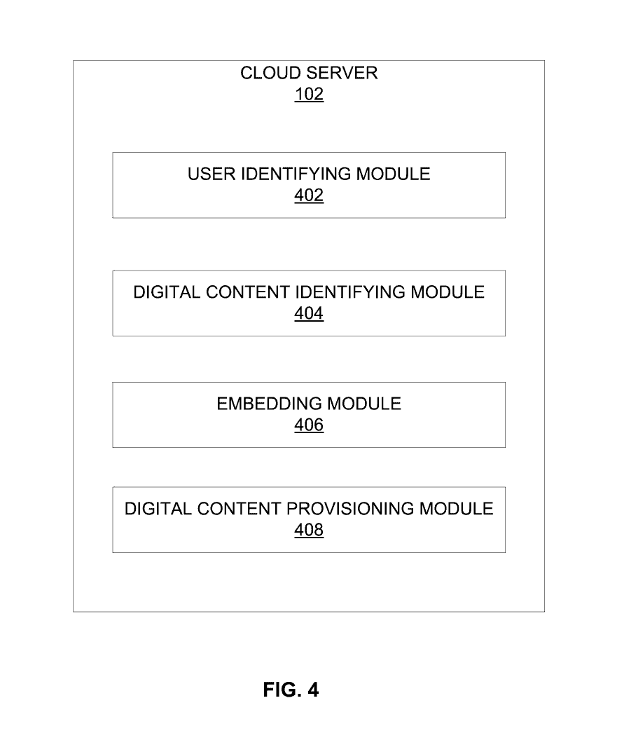

FIG. 4 is a functional block diagram of the cloud server 102 implemented by the system elements explained in conjunction with FIG. 3 above, in accordance with an embodiment.

The cloud server 102 includes a series of software modules for provisioning digital content.

In an exemplary embodiment, the cloud server 102 includes a user identifying module 402, a digital content identifying module 404, an embedding module 406, and a digital content provisioning module 408. The various modules work together to provision digital content. In another embodiment, the cloud server 102 includes a communication module configured for communicating with client devices associated with one or more users 104-108 over the Internet. The communication module may further include the user identifying module 402, the digital content identifying module 404, the embedding module 406, and the digital content provisioning module 408.

The user identifying module 402 identifies at least one user corresponding to each of a lifestyle based demographic and an interest in a domain. The cloud server 102 may identify the at least one user based on analyzing data corresponding to user behavior, such as purchasing behavior. In an exemplary embodiment, the user 108 may be interested in hybrid cars and may have also purchased a hybrid car recently. Therefore, the user identifying module 402 identifies that user is interested in a sustainable lifestyle based on the purchasing history comprising purchase of the hybrid car. Further, the user identifying module 402 may identify that the user is interested in the automotive domain.

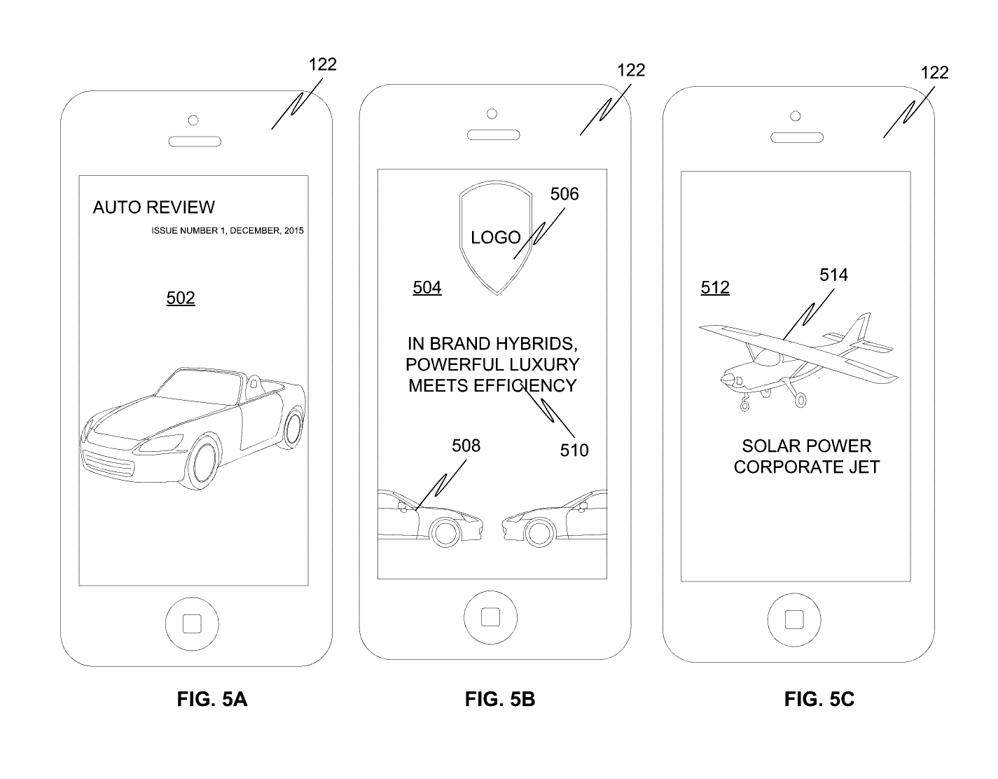

Thereafter, the digital content identifying module 404 identifies digital content corresponding to each of the lifestyle demographic and the domain. For example, for the user 108, the digital content identifying module 404 may identify an editorial article on latest improvements on hybrid cars. The editorial article may be displayed on a user interface 502 of the cell phone 122 of the user 108 as shown in FIG. 5A. Alternatively, the digital content may be a native advertisement of a new hybrid car launched by a car company. The native advertisement may be displayed on a user interface 504 of the cell phone 122 of the user 108 as shown in FIG. 5B. The native advertisement displayed on the user interface 504 includes a logo 506 of a car manufacturer, one or more images 508 of the new hybrid car and a description 510 of the new hybrid car. Further, the native advertising components may be designed to be highly interactive and engaging including videos, interactive pictures and hyperlinks to engage the reading audience.

Thereafter, the embedding module 406 embeds a brand in the digital content. The brand may correspond to at least one product and service. For the user 122, the brand may be associated with sustainability and the corresponding service also may be associated with sustainability. For example, the brand may be a service for renting a solar powered corporate jet. The embedded brand may be displayed on a user interface 512 of the cell phone 122 of the user 108 as shown in FIG. 5C. The embedded brand may include an image 514 of the solar powered corporate jet and description of the service.

Finally, the digital content provisioning module 408 provisions the digital content to the plurality of users. The provisioning of the digital content may be performed through a mobile application as shown in FIGS. 5A, 5B and 5C.

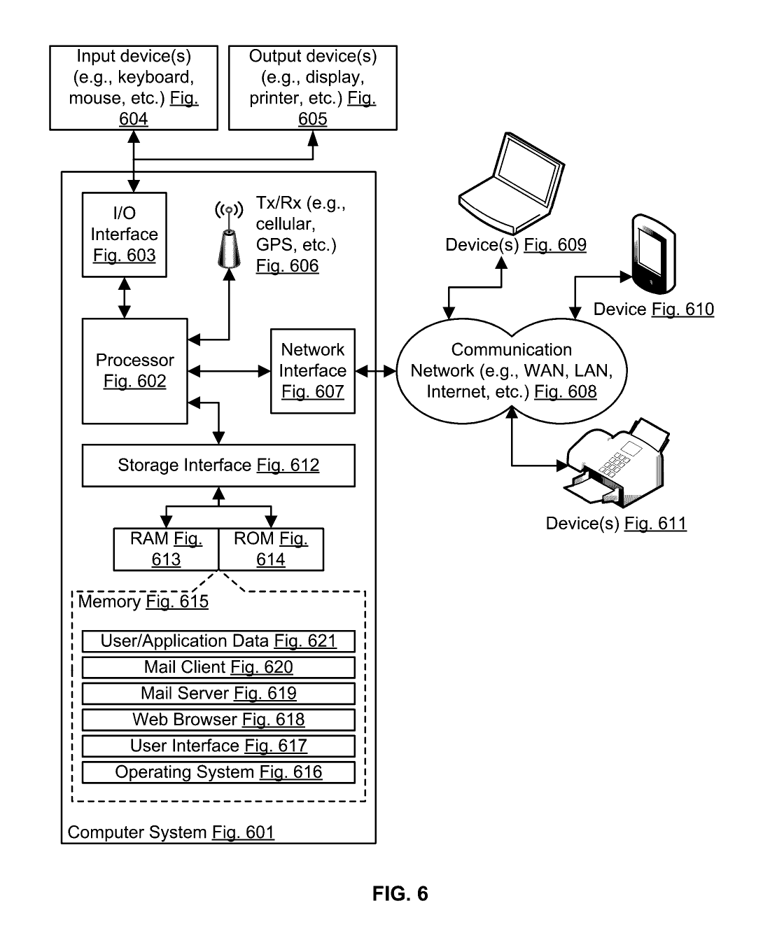

Referring now to FIG. 6, a block diagram of an exemplary computer system 601 for implementing embodiments consistent with the present disclosure is illustrated. Variations of computer system 601 may be used for implementing system 102 (the cloud server 102). Computer system 601 may comprise a central processing unit (“CPU” or “processor”) 602. Processor 602 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 602 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 602 may be disposed in communication with one or more input/output (I/O) devices via I/O interface 603. The I/O interface 603 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 603, the computer system 601 may communicate with one or more I/O devices. For example, the input device 604 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 605 may be a printer, fax machine, video display (e.g., cathode ray tube (CRT), liquid crystal display (LCD), light-emitting diode (LED), plasma, or the like), audio speaker, etc. In some embodiments, a transceiver 606 may be disposed in connection with the processor 602. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 602 may be disposed in communication with a communication network 608 via a network interface 607. The network interface 607 may communicate with the communication network 608. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 608 may include, without limitation, a direct interconnection, local area network (LAN), wide area network (WAN), wireless network (e.g., using Wireless Application Protocol), the Internet, etc. Using the network interface 607 and the communication network 608, the computer system 601 may communicate with devices 609, 610, and 611. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 601 may itself embody one or more of these devices.

In some embodiments, the processor 602 may be disposed in communication with one or more memory devices (e.g., RAM 613, ROM 614, etc.) via a storage interface 612. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices 615 may store a collection of program or database components, including, without limitation, an operating system 616, user interface application 617, web browser 618, mail server 619, mail client 620, user/application data 621 (e.g., any data variables or data records discussed in this disclosure), etc. The operating system 616 may facilitate resource management and operation of the computer system 601. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 617 may facilitate display, execution, interaction, manipulation, or operation of program components through textual or graphical facilities. For example, user interfaces may provide computer interaction interface elements on a display system operatively connected to the computer system 601, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 601 may implement a web browser 618 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 601 may implement a mail server 619 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 601 may implement a mail client 620 stored program component. The mail client may be a mail viewing application, such as Apple Mail, Microsoft Entourage, Microsoft Outlook, Mozilla Thunderbird, etc.

In some embodiments, computer system 601 may store user/application data 621, such as the data, variables, records, etc. (e.g., keywords, requirements, test cases, test scripts, sub requirements, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

I claim:

1. A system configured for provisioning digital content to users, the system comprising each of a communication module configured for communicating with a client computer associated with a user of the plurality of users over a communication network and a processor configured to:
a. identify a plurality of users corresponding to each of a lifestyle based demographic and an interest in a domain;
b. identify digital content corresponding to each of the lifestyle demographic and the domain;
c. embed a brand in the digital content, wherein the brand corresponds to at least one of a product and a service, wherein the brand is associated with at least one of eco-friendliness and sustainability; and
d. provision the digital content to the plurality of users.

2. The system of claim 1, wherein a lifestyle of the plurality of users is associated with at least one of eco-friendliness and sustainability.

3. The system of claim 1, wherein the lifestyle based demographic comprises a Lifestyles of Health and Sustainability (LOHAS) demographic.

4. The system of claim 1, wherein the brand comprises a luxury brand, wherein the at least one product comprises a luxury product and the at least one service comprises a luxury service.

5. The system of claim 1, wherein at least one of the product and the service is associated with at least one of eco-friendliness and sustainability.

6. The system of claim 1, wherein the digital content comprises an entertainment content.

7. The system of claim 6, wherein the digital content comprises at least one of a novel, a movie, a television series, an interactive game, a video and an interactive image.

8. The system of claim 6, wherein embedding comprises integrating at least one of the brand, the product and the service in a storyline corresponding to the entertainment content.

9. The system of claim 8, wherein the storyline is associated with at least one of eco-friendliness and sustainability.

10. The system of claim 1, wherein identifying the plurality of users comprises analyzing data corresponding to user behavior.

11. The system of claim 10, wherein the user behavior comprises purchasing behavior.

12. The system of claim 1, wherein the digital content comprises a native advertisement.

13. The system of claim 1, wherein the domain comprises at least one of alternative transport, alternative energy, climate change, biodiversity and conservation.

14. The system of claim 1, wherein the domain comprises at least one of auto sector, home sector, travel sector and general news.

15. The system of claim 1, wherein the digital content comprises editorial content, a news content and a user generated content.

16. The system of claim 1, wherein the processor is further configured to communicate at least one marketing message to the plurality of users.

17. The system of claim 1, wherein the marketing message is in the form of email.

18. The system of claim 1, wherein the provisioning of the digital content is performed through a mobile app.

19. The system of claim 1, wherein at least a part of the digital content is sponsored by an organization associated with the brand.

20. The system of claim 1, wherein the digital content comprises a sale offer to purchase at least one of the product and the service.

21. The system of claim 1, wherein provisioning the digital content results in recognition of at least one of the brand, the product and the service by the plurality of users as associated with at least one of eco-friendliness and sustainability.
